(19) United States
(12) Patent Application Publication
(10) Pub. No.: US 2008/0285974 A1
(43) Pub. Date: Nov. 20, 2008

(54) Optical Multiplexer/Demultiplexer

(75) Inventors: Makoto Takahashi, Kokubunji (JP); Yasunobu Matsuoka, Hachioji (JP); Masahiro Aoki, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/120,680

(22) Filed: May 15, 2008

(30) Foreign Application Priority Data
May 17, 2007 (JP) 2007-131204

(51) Int. Cl. H04J 14/02

(52) U.S. Cl. 398/87

(57) ABSTRACT

An optical multiplexer/demultiplexer comprising a member, of which first and second opposite planar surfaces are parallel to each other. The member includes therein a void, of which third and fourth opposite planar surfaces are in parallel to each other. An extension of a first line lying on the first planar surface and an extension of a third line lying on the third planar surface intersect each other in a cross section including the void of the member, a smaller one of intersection angles thereof being φ1. An extension of a second line lying on the second planar surface and an extension of a fourth line lying on the fourth planar surface intersect each other, a smaller one of intersection angles thereof being φ1. The third planar surface is provided on a part thereof with at least one high reflection coating film. The fourth planar surface is provided on a part thereof with at least one optical wavelength filter. At least parts of the high reflection coating film and the first optical wavelength filter are opposed to each other. The first optical wavelength filter transmits therethrough light of wavelength λ1 and reflects light of wavelength λ2 (here, wavelength λ1≠wavelength λ2). The member and an interior of the void are different in value of refractive index from each other.

### CLAIM OF PRIORITY

The present application claims priority from Japanese application JP 2007-131204 filed on May 17, 2007, the content of which is hereby incorporated by reference into this application.

### BACKGROUND OF THE INVENTION

The present invention relates to an optical multiplexer/demultiplexer, and more particular, to the construction of an optical multiplexer/demultiplexer for use in wavelength division multiplexing optical transmission and bidirection transmission over a single optical fiber, and a method of manufacturing the same.

With an increase in communications traffic in recent years, wavelength division multiplexing optical transmission, in which a plurality of wavelengths are transmitted over a single optical fiber, and bidirection transmission over a single optical fiber are going to spread. In these optical transmission, an optical multiplexer/demultiplexer is essential, in which optical signals having different wavelengths and transmitted through a plurality of separate optical fibers are multiplexed in a single optical fiber and conversely, optical signals having different wavelengths and transmitted through a single optical fiber are demultiplexed in a plurality of separate optical fibers.

FIG. 26 is a cross sectional view showing the conventional construction of an optical multiplexer/demultiplexer disclosed in JP-A-61-149906. An exemplary operation of this optical multiplexer/demultiplexer is as follows.

Optical signals having different wavelengths λ1, λ2 . . . enter a prism 90 through a spacer prism 91 from an optical fiber collimator 40. Here, the prism 90 is arranged by the spacer prisms 91, 92 so that light incoming and outgoing surfaces have an angle φ1 to a direction perpendicular to an optical axis of the optical fiber collimator 40. Also, the prism 90 and the spacer prisms 91, 92 are made of the same material and their refractive indexes are equal to one another. With this construction, light goes on a straight line also when entering the prism 90 from the spacer prism 91 and reaches an optical wavelength filter 21 provided on a surface of the prism 90 opposed to the spacer prism 91. Here, when the optical wavelength filter 21 is set in characteristics so as to transmit therethrough only light of wavelength λ1 and to reflect light of other wavelengths, the light of wavelength λ1 enters an optical fiber collimator 41 via the spacer prism 92. Also, the light reflected by the optical wavelength filter 21 reaches the other surface of the prism 90 to be reflected by a high reflection coating film 31 provided there to reach an optical wavelength filter 22 provided in a further location on that surface, on which the optical wavelength filter 21 is provided. Here, when the optical wavelength filter 22 is set in characteristics so as to transmit therethrough only light of wavelength λ2 and to reflect light of other wavelengths, the light of wavelength λ2 enters an optical fiber collimator 42 via the spacer prism 92. With the construction, lights of wavelength λ1, λ2, . . . can be sequentially demultiplexed to the optical fiber collimators 41, 42, . . . . In addition, while an explanation is given taking demultiplexing as an example, multiplexing can be performed when a sense, in which light advances, is reversed. Also, when light 1 enters the prism 90 from the optical fiber collimator 41 and light having a different wavelength from that of the light 1 is simultaneously enters the prism 90 from at least one of the optical fiber collimators 41, 42, bidirection transmission over a single optical fiber becomes possible. In addition, while multiplexing is taken as an example in all the following descriptions, it goes without saying that the multiplexer/demultiplexer according to the invention disclosed herein has not only the demultiplexing function but also the multiplexing function and the function of bidirection transmission over a single optical fiber. Also, while anti-reflection coating is not referred to in the above description, anti-reflection coating is applied to all interfaces, on which the optical wavelength filter and the high reflection coating are not formed, and the same is the case with all constructions described later. In this manner, with the construction of the conventional example, a multiplexer/demultiplexer is formed but it is especially necessary to make the prism 90 distant from a fiber array formed by the optical fiber collimators 41, 42, . . . and so miniaturization becomes difficult because it is necessary to arrange the prism 90 obliquely to the collimators.

FIG. 27 is a cross sectional view showing an optical multiplexer/demultiplexer disclosed in JP-A-2006-285280 and thought of in order to solve the problem of the conventional example described above. The multiplexer/demultiplexer is constructed such that a prism block 93 with a plurality of prism functions accumulated therein, an optical wavelength filter array 94, and a light transmission block 95 are laminated. Here, inclined surfaces 603, 604 are formed on an upper surface of the prism block 93 to provide for the prism function. The inclined surfaces 603, 604 are formed so that angles of inclination thereof are made symmetrical with respect to a plane perpendicular to a plane of the drawing. Also, an air is present above the prism block 93, and all the prism block 93, the optical wavelength filter array 94, and the light transmission block 95 are made the same in refractive index. An example of an operation of the optical multiplexer/demultiplexer is as follows.

For example, optical signals having different wavelengths λ1, λ2, . . . enter the inclined surfaces 604 at an angle perpendicular to the upper surface of the prism block 93 from an optical fiber collimator 40. After being refracted by the inclined surfaces 604, the incident light goes on a straight line to a lower surface of the light transmission block 95 to be reflected by a high reflection coating film 31 provided there. Here, an angle θ2 of reflection is determined by an angle φ1 of inclination of the inclined surfaces 604, and refractive indexes of the prism block 93 and an air. Subsequently, the reflected light reaches an optical wavelength filter 21 provided in the optical wavelength filter array 94. Here, when the optical wavelength filter 21 is set in characteristics so as to transmit therethrough only light of wavelength λ1 and to reflect light of other wavelengths, the light of wavelength λ1 is transmitted through the optical wavelength filter 21 and then reaches the inclined surface 603 provided below an optical fiber collimator 41. At this time, since an angle of inclination of the inclined surface 603 to the upper surface of the prism block 93 assumes an absolute value φ1, which is equal to that of the inclined surface 604, the light of wavelength λ1 outgoes perpendicularly to the upper surface of the prism block 93 on the basis of Snell's law to enter the optical fiber collimator 41. Also, light reflected by the optical wavelength filter 21 reaches the high reflection coating film 31 again to be reflected thereby to reach the optical wavelength filter 22. Here, when the optical wavelength filter 22 is set in characteristics so as to transmit therethrough only light of wavelength λ2 and to reflect light of other wavelengths, the light of wavelength λ2 can enter an optical fiber collimator 42 in the same manner as the light of wavelength λ1. In this manner, with the construction, optical signals having wavelengths λ1, λ2, . . . can be demultiplexed into the optical fiber collimators 41, 42, . . . . Further, with the construction, since the upper surface of the prism block 93 and optical axes of the optical fiber collimators can be made perpendicular to each other, a distance between the both suffices to be small, thus enabling miniaturization of the optical multiplexer/demultiplexer.

With the construction disclosed in JP-A-2006-285280, however, the prism block 93 is complex in structure, so that it is necessary to fabricate it one by one by means of a casting mold or the like and so it is difficult to achieve mass-production and reduction in cost. Also, it is necessary to arrange all incoming and outgoing optical fiber collimators on a side of the upper surface of the prism block 93, which makes it difficult to provide a construction, in which input side fiber collimators and output side fiber collimators are arranged in opposition to each other, so that the structural design of a whole light module is decreased in freedom. Also, when it is tried to enable making an opposed arrangement of the fiber collimators in the above construction, an increase in number of constituent parts such prism blocks, etc. is brought about to lead to difficulty not only in mass-production and reduction in cost but also in miniaturization.

Hereupon, it is an object of the present invention to provide a construction capable of miniaturization of an optical multiplexer/demultiplexer for use in wavelength division multiplexing optical transmission, in which a plurality of wavelengths are transmitted over a single optical fiber, and bidirection transmission over a single optical fiber, a decrease in number of parts, and simplification of mounting and fabricating processes.

### SUMMARY OF THE INVENTION

According to one aspect of the present invention, there is provided an optical multiplexer/demultiplexer comprising a member, of which first and second opposite, planar surfaces are parallel to each other, and wherein the member includes therein a void, of which third and fourth opposite, planar surfaces are parallel to each other, an extension of a first line lying on the first planar surface and an extension of a third line lying on the third planar surface intersect each other in a cross section including the void of the member, a smaller one of intersection angles thereof being φ1, an extension of a second line lying on the second planar surface and an extension of a fourth line lying on the fourth planar surface intersect each other, a smaller one of intersection angles thereof being φ1, the third planar surface is provided on a part thereof with at least one high reflection coating film, the fourth planar surface being provided on a part thereof with at least one optical wavelength filter, at least parts of the high reflection coating film and the first optical wavelength filter are opposed to each other, the first optical wavelength filter transmits therethrough light of wavelength λ1 and reflects light of wavelength λ2 (here, wavelength λ1≠wavelength λ2), and the member and an interior of the void are different in value of refractive index from each other.

According to a further aspect of the present invention, there is provided an optical multiplexer/demultiplexer comprising a member, of which first and second opposite, planar surfaces are parallel to each other, and wherein the member includes therein a void, of which third and fourth opposite, planar surfaces are parallel to each other, the first planar surface and the third planar surface are parallel to each other, the first planar surface is partially removed to provide a fifth planar surface, a normal direction of the first planar surface and a normal direction of the fifth planar surface intersecting each other at an angle φ1, a high reflection coating film is provided on a part of the first planar surface, a first optical wavelength filter being provided on a part of the third or fourth planar surface, at least parts of the high reflection coating film and the first optical wavelength filter are opposed to each other with a part of the member therebetween, the second planar surface is partially removed to provide sixth and seventh planar surfaces separately from each other, a normal direction of the second planar surface and a normal direction of the sixth and seventh planar surfaces intersecting each other at an angle φ1, the fifth planar surface, the sixth planar surface, and the seventh planar surface being parallel to one another, and the first optical wavelength filter transmits therethrough light of wavelength λ1 and reflects light of wavelength λ2.

According to a still further aspect of the present invention, there is provided an optical multiplexer/demultiplexer comprising a member having first and second planar surfaces, which are parallel to each other, and wherein at least one high reflection coating film is provided on the first planar surface, at least one optical wavelength filter being provided on the second planar surface, at least parts of the high reflection coating film and the first optical wavelength filter are opposed to each other, and the first optical wavelength filter transmits therethrough light of wavelength λ1 and reflects light of wavelength λ2, which is different from the wavelength λ1.

According to the present invention, it is possible to enable miniaturization of an optical multiplexer/demultiplexer for use in wavelength division multiplexing optical transmission, in which a plurality of wavelengths are transmitted over a single optical fiber, and bidirection transmission over a single optical fiber, a decrease in number of parts, and simplification of mounting and fabricating processes.

Other objects, features and advantages of the invention will become apparent from the following description of the embodiments of the invention taken in conjunction with the accompanying drawings.

### BRIEF DESCRIPTION OF THE DRAWINGS

FIG. 1 is a plan view showing Embodiment 1 of an optical multiplexer/demultiplexer according to the invention;

FIG. 2 is a cross sectional view taken along the line II-II in FIG. 1;

FIG. 3 is a cross sectional view taken along the line III-III in FIG. 1;

FIG. 4 is a cross sectional view being the same as FIG. 2 and illustrating an operation of Embodiment 1;

FIG. 5 is a view illustrating a method of fabricating Embodiment 1;

FIG. 6 is a view illustrating a method of fabricating Embodiment 1;

FIG. 7 is a plan view showing Embodiment 1 in the case where an optical signal is of dual wavelength;

FIG. 8 is a cross sectional view taken along the line VIII-VIII in FIG. 7;

FIG. 9 is a cross sectional view taken along the line IX-IX in FIG. 7;

FIG. 10 is a cross sectional view being the same as FIG. 7 and illustrating an operation of Embodiment 1 in the case where an optical signal is of dual wavelength;

FIG. 11 is a view illustrating a method of fabricating Embodiment 1 in the case where an optical signal is of dual wavelength;

FIG. 12 is a cross sectional view being the same as FIG. 2 and showing Embodiment 2 of an optical multiplexer/demultiplexer according to the invention;

FIG. 13 is a cross sectional view being the same as FIG. 2 and showing Embodiment 2 in the case where an optical signal is of dual wavelength;

FIG. 14 is a cross sectional view being the same as FIG. 2 and showing Embodiment 3 of an optical multiplexer/demultiplexer according to the invention;

FIG. 15 is a cross sectional view being the same as FIG. 2 and showing Embodiment 3 in the case where an optical signal is of dual wavelength;

FIG. 16 is a cross sectional view being the same as FIG. 2 and showing Embodiment 4 of an optical multiplexer/demultiplexer according to the invention;

FIG. 17 is a cross sectional view being the same as FIG. 2 and showing Embodiment 4 in the case where an optical signal is of dual wavelength;

FIG. 18 is a cross sectional view being the same as FIG. 2 and showing Embodiment 5 of an optical multiplexer/demultiplexer according to the invention;

FIG. 19 is a cross sectional view being the same as FIG. 2 and showing Embodiment 5 in the case where an optical signal is of dual wavelength;

FIG. 20 is a cross sectional view being the same as FIG. 2 and showing Embodiment 6 of an optical multiplexer/demultiplexer according to the invention;

FIG. 21 is a cross sectional view being the same as FIG. 2 and showing Embodiment 6 in the case where an optical signal is of dual wavelength;

FIG. 22 is a cross sectional view being the same as FIG. 2 and showing Embodiment 7 of an optical multiplexer/demultiplexer according to the invention;

FIG. 23 is a cross sectional view being the same as FIG. 2 and showing Embodiment 7 in the case where an optical signal is of dual wavelength;

FIG. 24 is a cross sectional view being the same as FIG. 2 and showing Embodiment 8 of an optical multiplexer/demultiplexer according to the invention;

FIG. 25 is a cross sectional view being the same as FIG. 2 and showing Embodiment 8 in the case where an optical signal is of dual wavelength;

FIG. 26 is a cross sectional view showing an optical multiplexer/demultiplexer according to the related art; and

FIG. 27 is a cross sectional view showing an optical multiplexer/demultiplexer according to the related art.

### DESCRIPTION OF THE PREFERRED EMBODIMENTS

Embodiments of the invention will be described in detail with reference to the drawings.

### Embodiment 1

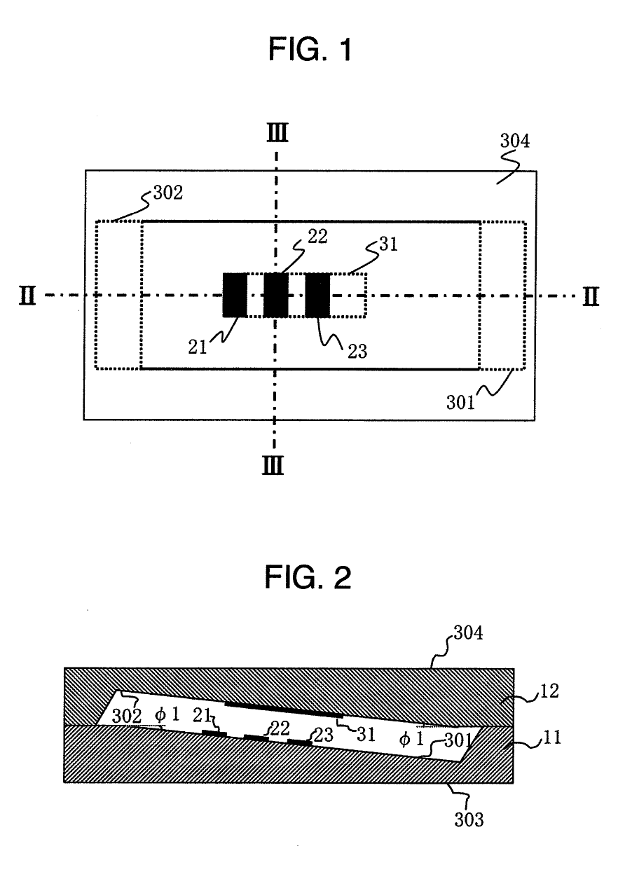

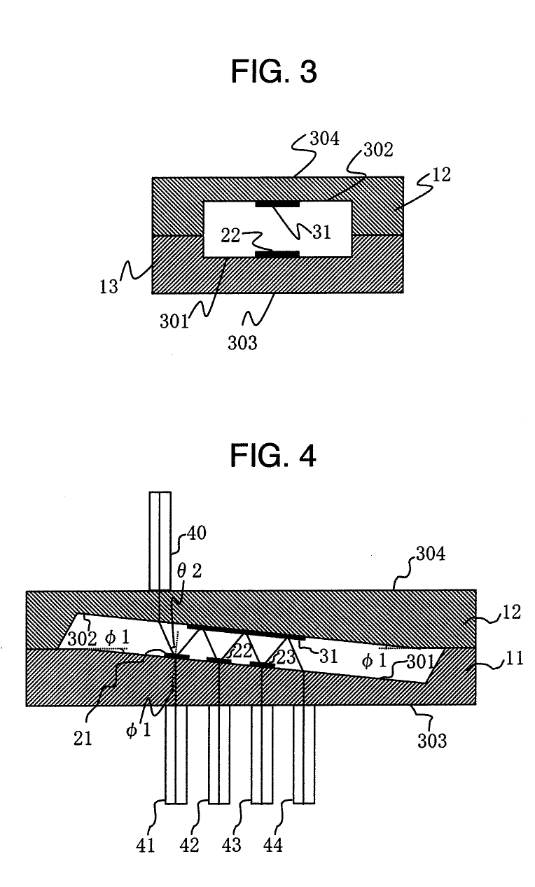

Embodiment 1 of the invention will be described with reference to FIGS. 1 to 6.

A construction comprises silicon substrates 11, 12 as worked. An inclined surface 301 having an angle φ1 to a substrate surface is formed on the silicon substrate 11. Further, optical wavelength filters 21, 22, 23 are formed on the inclined surface 301. Also, an inclined surface 302 having an angle φ1 to a substrate surface is formed on the silicon substrate 12. Further, a high reflection coating film 31 is formed on the inclined surface 302. The silicon substrates 11, 12 are bonded together so as to make the inclined surfaces 301, 302 in parallel to and in opposition to each other, thereby enabling fabricating an optical multiplexer/demultiplexer according to Embodiment 1 of the invention. In addition, an air surrounds the silicon substrates 11, 12. In addition, an air is not necessarily present between the inclined surface 301 and the inclined surface 302 but a material will do, which is permeable to transmitted light and has a different refractive index from that of silicon.

FIG. 4 is a cross sectional view showing an operation of Embodiment 1 of the invention. Here, an explanation is given taking a demultiplexing function as an example. First, an optical fiber collimator 40 is arranged perpendicularly to a substrate surface 304 of the silicon substrate 12, on which the inclined surface 302 is not formed, and multiplexed signal light having different wavelengths λ1, λ2, . . . , λn is entered toward the inclined surface 302 from the substrate surface 304. A combination of wavelengths is conceivable, in which, for example, 1.31 μm, 1.49 μm, and 1.55 μm, which transmits through silicon, are made λ1, λ2, λ3, respectively. The light is refracted by the inclined surface 302 and then reaches the optical wavelength filter 21 formed on the inclined surface 301. Here, when the optical wavelength filter 21 is fabricated so as to transmit therethrough only light of wavelength λ1 and light of adjacent wavelength but to reflect light of other wavelengths, it is possible to make the light of wavelength λ1 outgo toward the optical fiber collimator 41. Also, light reflected by the optical wavelength filter 21 is reflected by the high reflection coating film 31 formed on the inclined surface 302 to reach the optical wavelength filter 22. Thereafter, by changing the optical wavelength filters 22, 23, . . . in characteristics, it is possible to make lights of wavelengths λ2, λ3, . . . enter optical fiber collimators 42, 43, . . . . Here, the optical wavelength filters 22, 23, . . . may be separate from, or in contact with one another. In this manner, the construction realizes the demultiplexing function. Here, since the inclined surfaces 301, 302 are parallel to each other, the substrate surfaces 303, 304 are parallel to each other, and incident light from the optical fiber collimator 40 is perpendicular to the substrate surface 304, incident light to the optical fiber collimators 41, 42, . . . is made perpendicular to the substrate surface 303. Accordingly, the optical fiber collimators 41, 42, . . . can be arranged perpendicularly to the substrate surface 303, thus enabling miniaturization. Also, those parts, which determine the size of the present optical multiplexer/demultiplexer, are only two, that is, the silicon substrates 11, 12, thus enabling fabricating a small-sized optical multiplexer/demultiplexer in this respect.

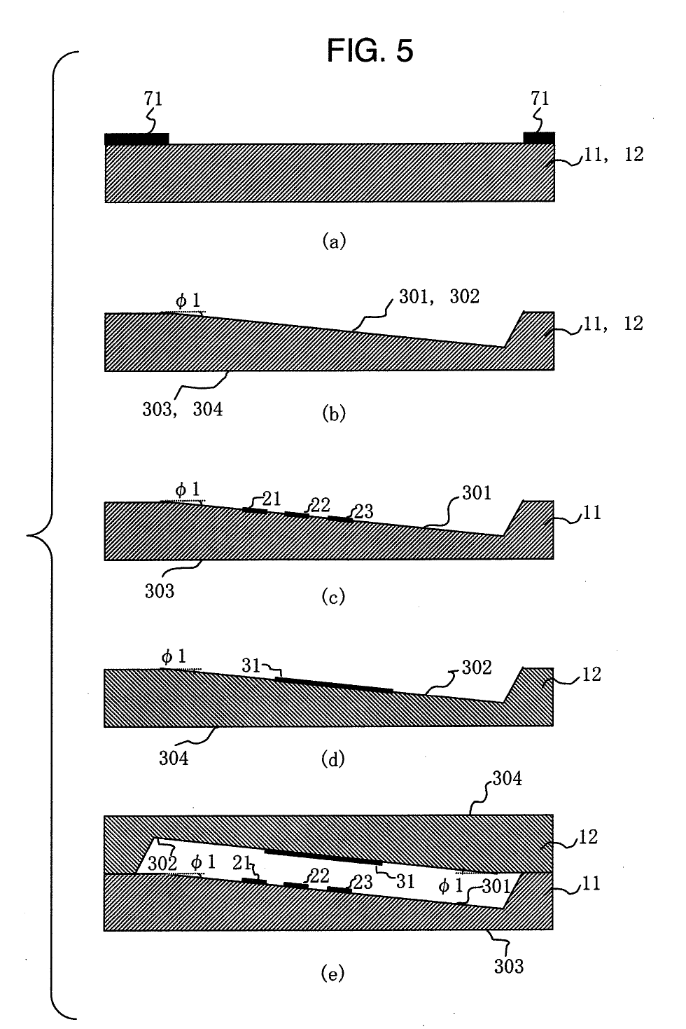

FIG. 5 illustrates a method of fabricating the present optical multiplexer/demultiplexer. First, an etching mask 71 is formed on silicon substrates 11, 12 cut with an off angle so that a substrate surface has an angle of φ1 to a (111) plane (FIG. 5(a)).

Subsequently, an etchant, such as KOH water solution, which will expose the (111) plane of silicon, is used to subject the silicon substrates 11, 12 to wet etching to form inclined surfaces 301, 302, and then the etching masks 71 are removed (FIG. 5(b)). Subsequently, optical wavelength filters 21 to 23 are formed on the inclined surface 301 of the silicon substrate 11 by deposition or bonding (FIG. 5(c)). Also, a high reflection coating film 31 is formed on the inclined surface 302 of the silicon substrate 12 by deposition or bonding (FIG. 5(d)). Finally, when the silicon substrate 11 and the silicon substrate 12 are bonded together so that the inclined surfaces 301, 302 are opposed to each other, the present optical multiplexer/demultiplexer is completed (FIG. 5(e)). Here, it goes without saying that fabrication in the processes (a) to (d) can be performed in an ordinary wafer process.

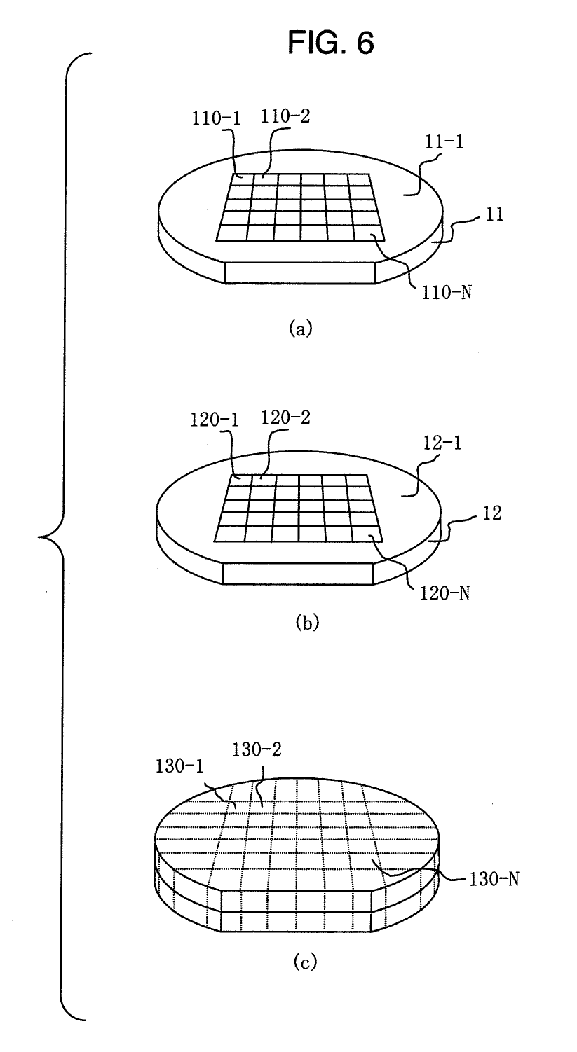

Further, fabrication in the process (e) can be performed in wafer level. FIG. 6 illustrates a manner, in which the fabrication is performed. First, in the processes shown in FIGS. 5(a) to 5(d), a silicon substrate 11 is fabricated, in which inclined surfaces 301 and optical wavelength filters 21 to 23 are formed in addresses 110-1, 110-2, , 110-N on a substrate surface 11-1 (FIG. 6(a)). Further, in the processes shown in FIGS. 5(a) to 5(d), inclined surfaces 302 and high reflection coating films 31 are formed on a substrate surface 12-1 of a silicon substrate 12, on which addresses 120-1, 120-2, . . . , 120-N correspond to those on the silicon substrate 11 (FIG. 6(b)). Finally, when a substrate formed by bonding the substrate surface 11-1 and the substrate surface 12-1 to stick the silicon substrate 11 and the silicon substrate 12 together with the addresses 110-1, 110-2, 110-N overlapping the addresses 120-1, 120-2, . . . , 120-N is subjected to dicing along boundaries of the addresses, a multiplicity of optical multiplexer/demultiplexers 130-1, 130-2, . . . , 130-N are fabricated in a lump (FIG. 6(c)).

As described above, the construction can realize a small-sized optical multiplexer/demultiplexer, of which parts are small in number, in simple processes capable of readily achieving mass-production.

In addition, an optical fiber collimator used herein can be replaced with an ordinary optical fiber. In this case, it suffices to arrange a collimator lens between an optical fiber and the silicon substrate 12.

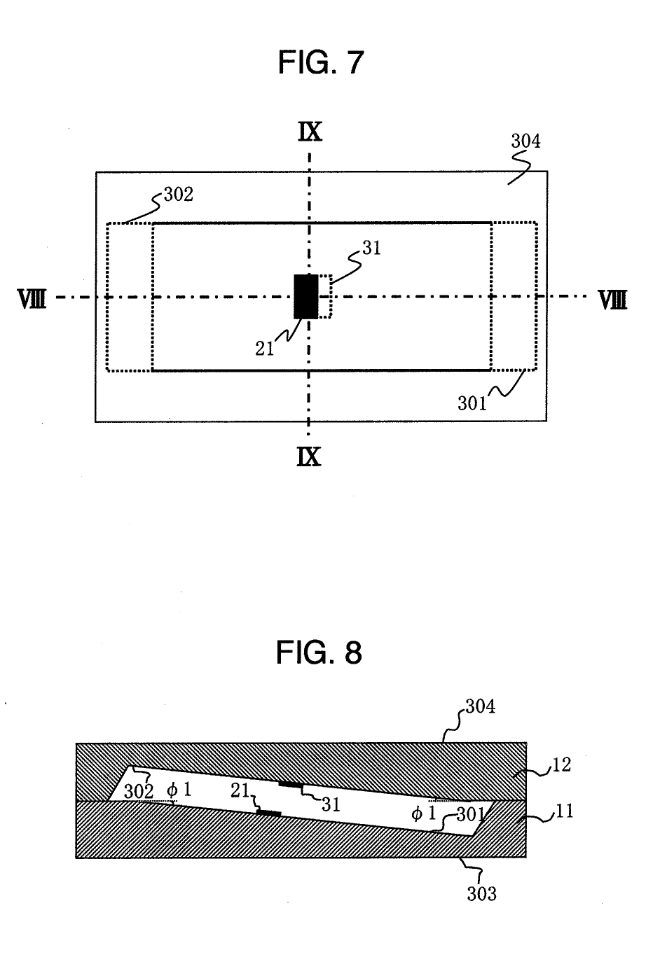

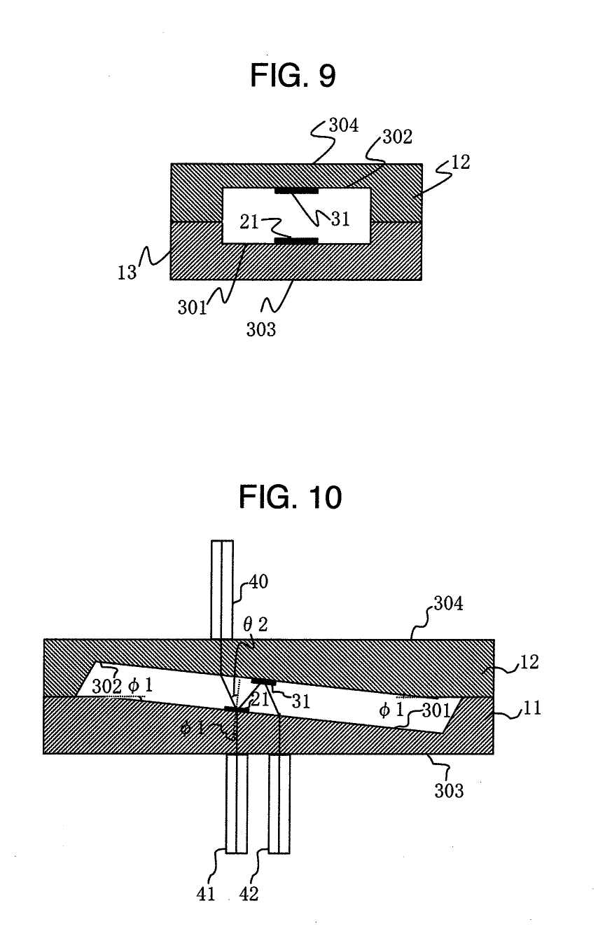

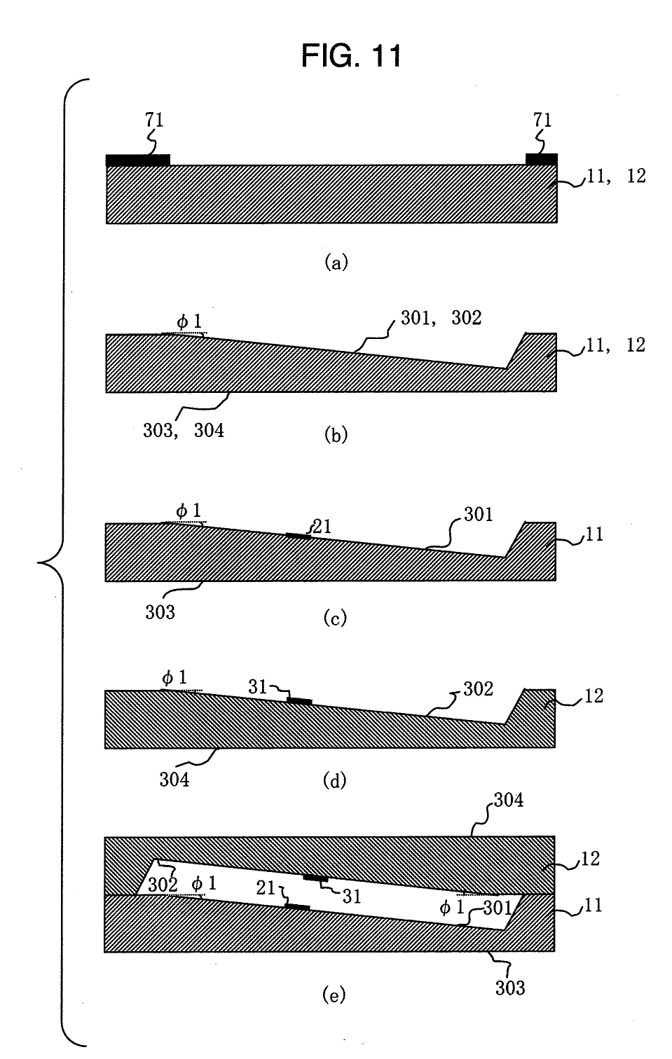

The present construction is of course effective in the case where an optical signal as used is of dual wavelength. FIGS. 7, 8, 9, 10, and 11, respectively, illustrate a construction, an operation, and a fabrication method in case of dual wavelength. Also, it goes without saying that fabrication in wafer processes shown in FIG. 6 is possible also in case of dual wavelength.

### Embodiment 2

FIG. 12 is a cross sectional view showing Embodiment 2 of the invention. Lenses 50, 51, 52, 53, 54 are integrated on light paths on the substrate surfaces 303, 304 of the silicon substrate in the construction of Embodiment 1 shown in FIG. 4. With the construction, an optical multiplexer/demultiplexer has lens function whereby instead of expensive optical fiber collimators, ordinary optical fibers 80, 81, 82, 83, 84 can be used in incoming and outgoing of light, so that further reduction in cost is enabled. Here, in order to integrate the lenses 50, 51, 52, 53, 54, it suffices to subject, for example, the substrate surfaces 303, 304 to etching.

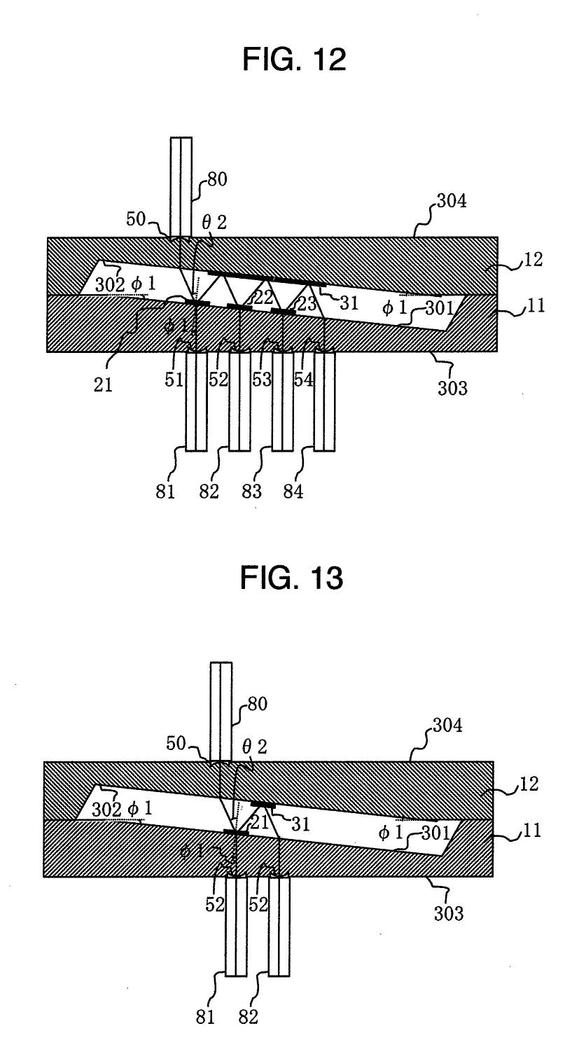

The present construction is of course effective in the case where an optical signal as used is of dual wavelength. FIG. 13 is a cross sectional view in case of dual wavelength. Also, it goes without saying that fabrication in wafer processes shown in FIG. 6 is possible in case of dual wavelength.

### Embodiment 3

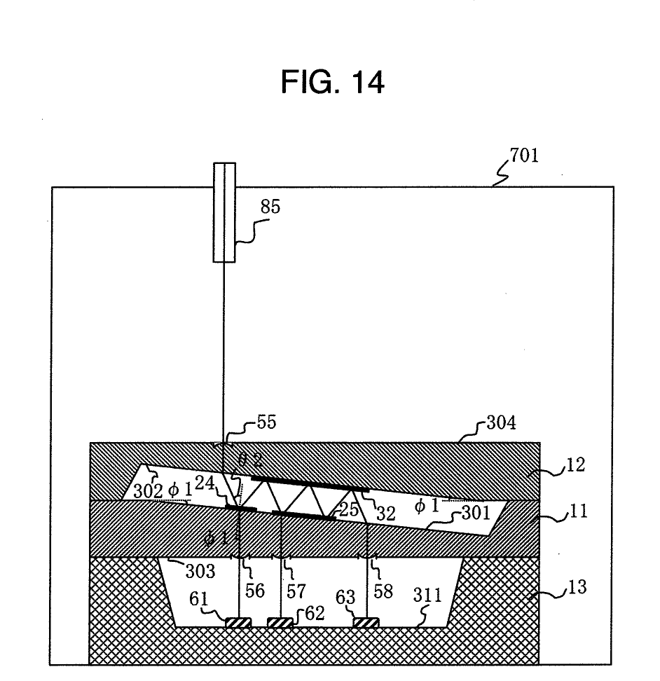

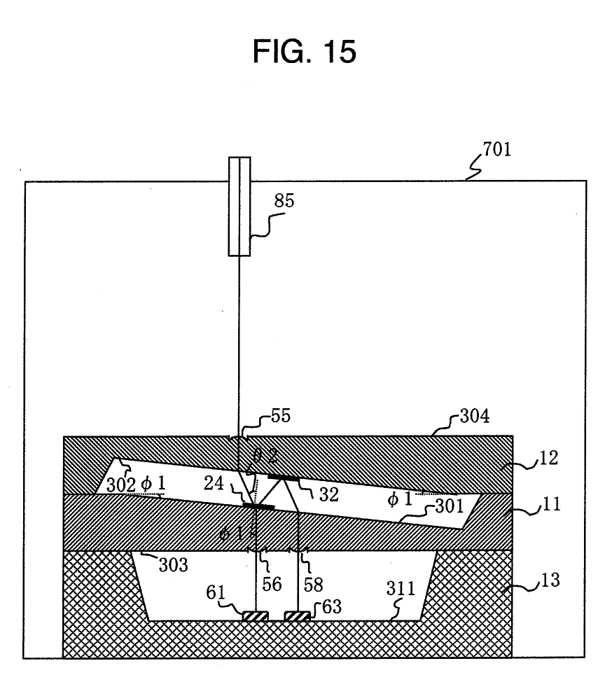

FIG. 14 is a cross sectional view showing Embodiment 3 of the invention. This is an example, in which a similar construction to that of Embodiment 2 shown in FIG. 12 is used to fabricate an optical transmitter and receiver for bidirection transmission over a single optical fiber. In the present construction, the optical multiplexer/demultiplexer shown in FIG. 12 is laminated and integrated on an optical device mount plate 13 having an optical device mount surface 311. Here, the optical device mount plate 13 can be fabricated by subjecting, for example, a silicon substrate to wet etching. In the optical transmitter and receiver, light (optical signal subjected to wavelength division multiplexing and referred to in the invention ordinarily indicates such multiplexed light. The same is the case in the following.), into which lights having two wavelengths of λ1 and λ2 are multiplexed, is made entered perpendicularly to the substrate surface 304 from an optical fiber 85. The light is collimated by a lens 55 provided on the substrate surface 304 to be refracted by the inclined surface 302 to reach an optical wavelength filter 24 formed on the substrate surface 301. Here, when the optical wavelength filter 24 is set in characteristics so as to transmit therethrough only light of wavelength λ1 and to reflect light of other wavelengths, the light of wavelength λ1 is refracted and transmitted through the optical wavelength filter 24 to advance in a direction perpendicular to the substrate surface 303, and adjusted in beam diameter by a lens 56 formed on the substrate surface 303 to be thereafter received by a photo-detector 61. On the other hand, the light of the wavelength λ2 is reflected by the optical wavelength filter 24 to be thereafter reflected further by a high reflection coating film 32 formed on an inclined surface 302 to reach an optical wavelength filter 25 formed on an inclined surface 301. Here, when the optical wavelength filter 25 is set in characteristics so as to transmit therethrough only light of wavelength λ2 and to reflect light of other wavelengths, the light of wavelength λ2 is received by a photo-detector 62 in the same manner as the light of wavelength λ1. Also, a laser diode 63 mounted on the optical device mount surface 311 causes light of wavelength λ3 to outgo perpendicularly to the substrate surface 303 of the silicon substrate 11, which forms the optical multiplexer/demultiplexer. The light of wavelength λ3 is collimated by a lens 58 to be thereafter refracted by the inclined surface 301 to reach a high reflection coating film 32 formed on an inclined surface 302 to be thereafter reflected to reach an optical wavelength filter 25 formed on the inclined surface 303. Here, since the optical wavelength filter 25 is designed to reflect light of wavelength λ3, the light of wavelength λ3 is repeatedly reflected between the optical wavelength filter 25 and the high reflection coating film 32 to reach an optical wavelength filter 24 formed on the inclined surface 301. Since the optical wavelength filter 24 is also designed to reflect the light of wavelength λ3, the light of wavelength λ3 is reflected to reach the inclined surface 302 to be refracted thereby to advance in a direction perpendicular to the substrate surface 304 to pass through the lens 55 to be transmitted to the optical fiber 85. In this manner, the present optical multiplexer/demultiplexer is used to enable realizing a small-sized optical transmitter and receiver for bidirection transmission over a single optical fiber, which can be readily fabricated. In addition, the optical fiber 85 is fixed by a package 701 made of metal or the like. Also, the package 701 is omitted in the following descriptions.

The present construction is of course effective in the case where an optical signal as used is of dual wavelength. FIG. 15 is a cross sectional view in case of dual wavelength. In the construction shown in FIG. 15, the light of wavelength λ1 from the optical fiber 85 enters a photo-detector 61 and the light of wavelength λ3 from a laser diode 63 enters the optical fiber 85. Also, the construction is not limited only to duplex communication. When optical devices as mounted are all photo-detectors or all laser diodes, it is possible to form an optical module for unidirectional wavelength division multiplexing optical transmission.

### Embodiment 4

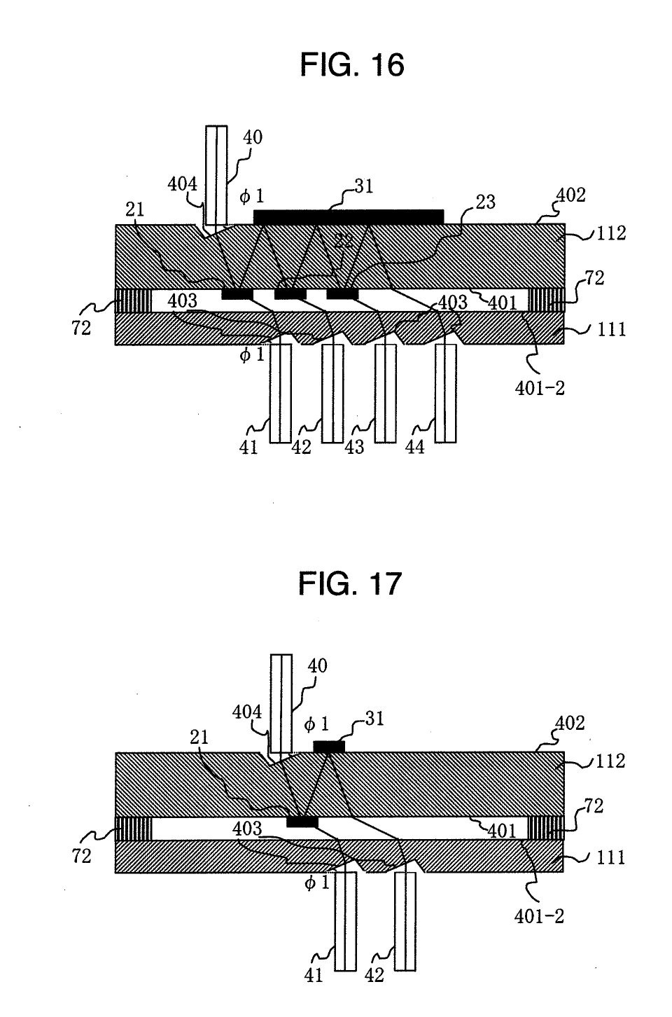

FIG. 16 is a cross sectional view showing Embodiment 4 of the invention. In the present construction, a silicon substrate 112 is laminated on a silicon substrate 111 with a spacer member 72 therebetween. Here, it is possible to fill an air, gases, or fill a substance such as filler, etc. between the silicon substrate 112 and the silicon substrate 111, or to put the substance in voids. In short, it suffices that the voids be permeable to transmitted light.

Optical wavelength filters 21, 22, 23 are formed on a substrate surface 401 of the silicon substrate 112, which are in contact with the spacer member 72, and a high reflection coating film 31 is formed on the other substrate surface 402. Also, an inclined surface 404 having an angle φ1 of inclination is formed on the substrate surface 402 of the silicon substrate 112. Also, two or more inclined surfaces 403 having an angle φ1 of inclination are formed on that substrate surface of the silicon substrate 111, which are not in contact with the spacer member 72. The silicon substrate 111 and the silicon substrate 112 are arranged so that the inclined surfaces 403 and the inclined surface 404 are in parallel with each other. Also, an optical fiber collimator 40 is arranged above the inclined surface 404 so as to make an optical axis thereof perpendicular to the substrate surface 402. Also, optical fiber collimators are arranged one by one below the inclined surfaces 403. Here, in the case where the present construction is used for an optical demultiplexer, it suffices that a signal light having different wavelengths λ1, λ2, . . . be made entered in a direction toward the inclined surface 404 and perpendicular to the substrate surface 402. The light is refracted by the inclined surface 404 to thereafter advance in the silicon substrate 112 to reach the optical wavelength filter 21. Here, when the optical wavelength filter 21 is set in characteristics so as to transmit therethrough only light of wavelength λ1 and to reflect light of other wavelengths, the light of wavelength λ1 is transmitted through the optical wavelength filter 21 to pass through an air layer and the silicon substrate 111 to pass through the inclined surface 403 to outgo toward the optical fiber collimator 41. Here, when substrate surfaces of the silicon substrate 112 and the silicon substrate 111 are arranged in parallel to each other, light outgoing toward the optical fiber collimator 41 is made perpendicular to the substrate surface of the silicon substrate 111 on the basis of Snell's law because the inclined surfaces 403, 404 are arranged in parallel to each other. Accordingly, it suffices to arrange the optical fiber collimator 41 perpendicularly to the silicon substrate 111. Also, light reflected by the optical wavelength filter 21 reaches a high reflection coating film 31 provided on the substrate surface 402 of the silicon substrate 112 to be thereafter reflected to reach the optical wavelength filter 22 formed on the substrate surface 401 of the silicon substrate 112. Here, by adjusting the optical wavelength filters 22, 23 in characteristics, it is possible to make light of wavelength λ2, light of wavelength λ3, and light of wavelength λ4, respectively, enter the optical fiber collimators 42, 43, 44 in the same manner as the light of wavelength λ1. Here, light outgoing toward any one of the optical fiber collimators is made perpendicular to the substrate surface of the silicon substrate 111 in the same manner as the light of wavelength λ1. Accordingly, since any one of the optical fiber collimators can be arranged perpendicularly to the substrate surface of the silicon substrate 111, the present optical multiplexer/demultiplexer can be formed to be made small. Also, the construction of the present embodiment enables fabrication in simple wafer processes shown in FIGS. 5 and 6 and suited to mass-production in the same manner as that of Embodiment 1.

In addition, with the construction, a part or a whole of the optical wavelength filters 21, 22, 23, . . . may be provided on a substrate surface 401-2 of the silicon substrate 111 opposed to the substrate surface 401 of the silicon substrate 112 with the spacer member 72 therebetween.

The present construction is of course effective in the case where an optical signal as used is of dual wavelength. FIG. 17 is a cross sectional view in case of dual wavelength. Also, it goes without saying that fabrication in wafer processes shown in FIG. 6 is possible in case of dual wavelength.

### Embodiment 5

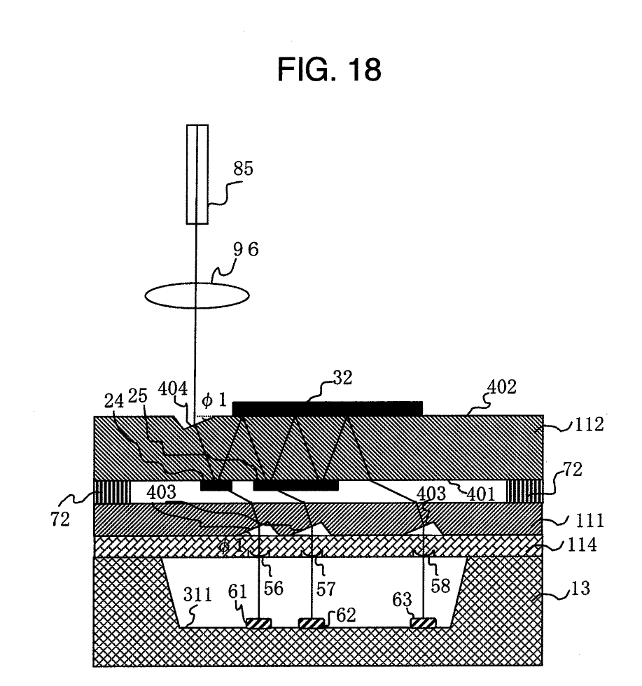

FIG. 18 is a cross sectional view showing Embodiment 5 of the invention. This is an example, in which a similar construction to that of Embodiment 4 shown in FIG. 16 is used to fabricate an optical transmitter and receiver for bidirection transmission over a single optical fiber. In the present construction, the optical multiplexer/demultiplexer shown in FIG. 16 is laminated and integrated on an optical device mount plate 13 having an optical device mount surface 311. Here, a lens array substrate 114 fabricated by working a silicon substrate is interposed between the optical multiplexer/demultiplexer and the optical device mount plate 13. Here, the optical device mount plate 13 can be fabricated by subjecting, for example, a silicon substrate to wet etching. In the optical transmitter and receiver, the same operation of an optical transmitter and receiver for bidirection transmission over a single optical fiber as that of the optical transmitter and receiver of Embodiment 3 is obtained on the basis of the same principle as that of Embodiment 4. In addition, according to the embodiment, since no lens is formed on a silicon substrate 112, a lens 96 is arranged between an optical fiber 85 and an inclined surface 404.

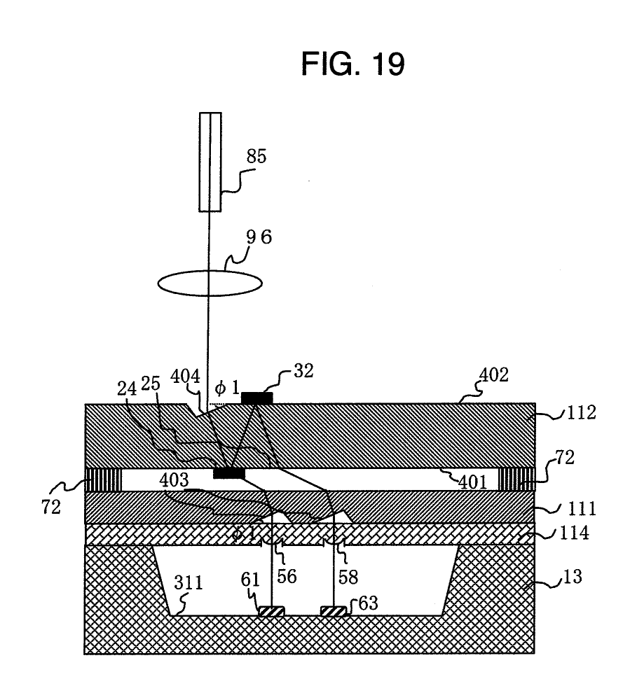

The present construction is of course effective in the case where an optical signal as used is of dual wavelength. FIG. 19 is a cross sectional view in case of dual wavelength. In the construction shown in FIG. 19, the light of wavelength λ1 from an optical fiber 85 enters a photo-detector 61 and the light of wavelength λ3 from a laser diode 63 enters the optical fiber 85. Also, the construction is not limited only to duplex communication. When optical devices as mounted are all photo-detectors or all laser diodes, it is possible to form an optical module for unidirectional wavelength division multiplexing optical transmission.

### Embodiment 6

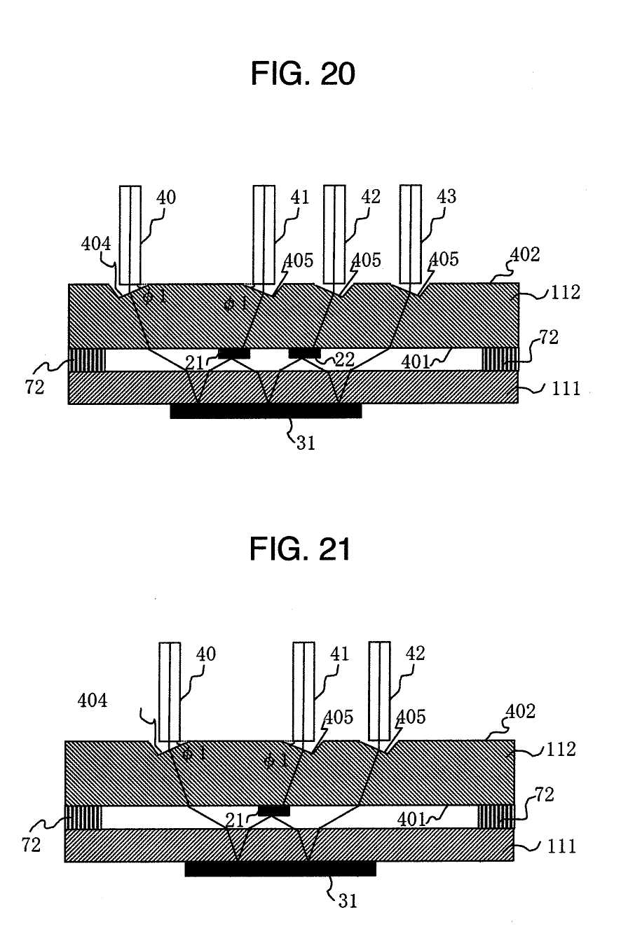

FIG. 20 is a cross sectional view showing Embodiment 6 of the invention. In the embodiment, the construction of Embodiment 4 shown in FIG. 16 is modified so that both incoming and outgoing of light are performed on the same plane. In the construction, a silicon substrate 112 is laminated on a silicon substrate 111 with a spacer member 72 therebetween. Here, an air is present between the silicon substrate 112 and the silicon substrate 111. Optical wavelength filters 21, 22 are formed on a substrate surface 401 of the silicon substrate 112, which is in contact with the spacer member 72, and a single inclined surface 404 having an angle φ1 of inclination is formed on the other substrate surface 402. Further, the substrate surface 402 and a plurality of inclined surfaces 405 made symmetrical with respect to a plane perpendicular to a plane of the drawing are formed on the substrate surface 402. Also, a high reflection coating film 31 is formed on that substrate surface of the silicon substrate 111, which is not in contact with the spacer member 72. Here, in the case where the present construction is used for an optical demultiplexer, it suffices that from an optical fiber collimator 40, a signal light having different wavelengths λ1, λ2, . . . is put in a direction toward the inclined surface 404 and perpendicular to the substrate surface 402. The light signal is refracted by the inclined surface 404 to thereafter advance in the silicon substrate 112, an air layer, and the silicon substrate 111 to reach the high reflection coating film 31 and thereafter advances again in the silicon substrate 111 and the air layer to reach the optical wavelength filter 21.

Here, when the optical wavelength filter 21 is set in characteristics so as to transmit therethrough only light of wavelength λ1 and to reflect light of other wavelengths, the light of wavelength λ1 is transmitted through the optical wavelength filter 21 to pass through the silicon substrate 112 to pass through the inclined surface 405 to outgo toward an optical fiber collimator 41. Here, when substrate surfaces of the silicon substrate 112 and the silicon substrate 111 are arranged in parallel to each other, light outgoing toward the optical fiber collimator 41 is made perpendicular to the substrate surface of the silicon substrate 111 on the basis of Snell's law because angles of inclination of the inclined surfaces 403, 404 are the same in absolute value. Accordingly, it suffices to arrange the optical fiber collimator 41 perpendicularly to the silicon substrate 112.

Also, light reflected by the optical wavelength filter 21 passes through the air layer and the silicon substrate 111 to reach the high reflection coating film 31 to be reflected and advances again in the silicon substrate 111 and the air layer to reach an optical wavelength filter 22 formed on the substrate surface 401 of the silicon substrate 112. Here, by adjusting the optical wavelength filters 22, 23 in characteristics, it is possible to make light of wavelength λ2 and light of wavelength λ3, respectively, enter the optical fiber collimators 42, 43 in the same manner as the light of wavelength λ1. Here, light outgoing toward any one of the optical fiber collimators is made perpendicular to the substrate surface 402 of the silicon substrate 112 in the same manner as the light of wavelength λ1. Accordingly, since any one of the optical fiber collimators can be arranged perpendicularly to the substrate surface 402 of the silicon substrate 112, the present optical multiplexer/demultiplexer can be formed to be made small. Also, the construction of the present embodiment enables fabrication in simple wafer processes shown in FIGS. 5 and 6 and suited to mass-production in the same manner as that of Embodiment 1. Here, in the case where it is difficult to form angles of the inclined surfaces 404, 405 by means of wet etching, fabrication may be made by means of dry etching.

The present construction is of course effective in the case where an optical signal as used is of dual wavelength. FIG. 21 is a cross sectional view in case of dual wavelength. Also, it goes without saying that fabrication in wafer processes shown in FIG. 6 is possible in case of dual wavelength.

### Embodiment 7

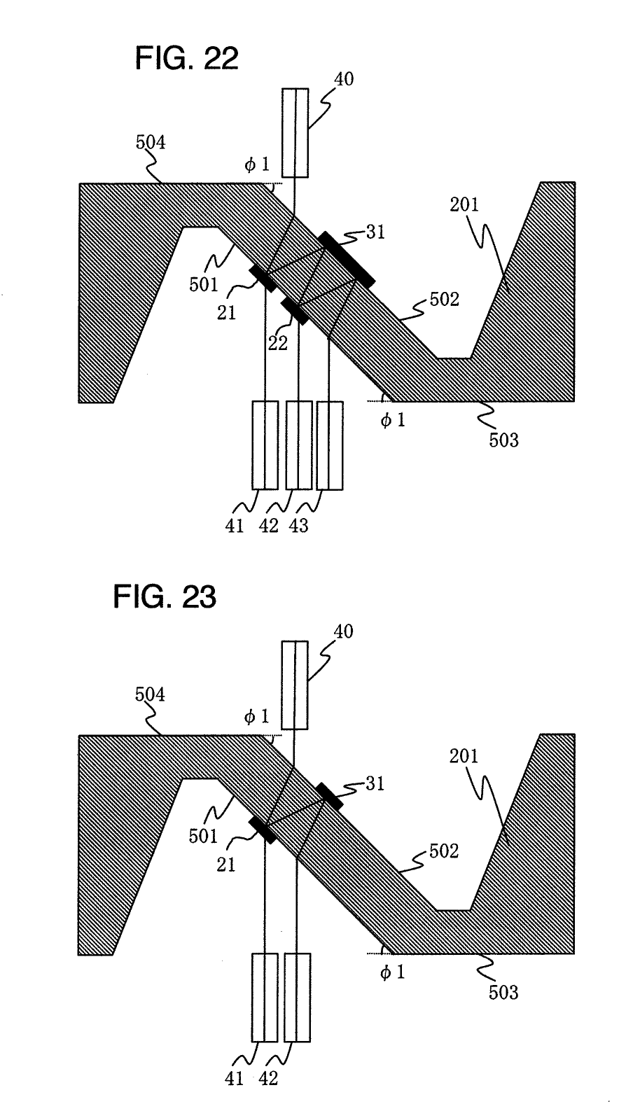

FIG. 22 is a cross sectional view showing Embodiment 7 of the invention. The present construction comprises a silicon substrate 201 as worked. In the construction, an inclined surface 501 having an angle φ1 of inclination is formed on one 503 of substrate surfaces of the silicon substrate 201 and an inclined surface 502 having the same angle φ1 of inclination is formed on the other 504 of the substrate surfaces so as to be made parallel to the inclined surface 501. At this time, as shown in the drawing, silicon is present between the inclined surfaces 501, 502. Also, in the construction, optical wavelength filters 21, 22 are formed on the inclined surface 501 and a high reflection coating film 31 is formed on the inclined surface 502. Here, in the case where the present construction is used for an optical demultiplexer, it suffices that from an optical fiber collimator 40, a signal light having different wavelengths λ1, λ2, . . . enters in a direction toward the inclined surface 502 and perpendicular to the substrate surface 504. The light is refracted by the inclined surface 502 to thereafter advance in the silicon substrate 201 to reach a high reflection coating film 21. Here, when the optical wavelength filter 21 is set in characteristics so as to transmit therethrough only light of wavelength λ1 and to reflect light of other wavelengths, the light of wavelength λ1 is refracted and transmitted through the optical wavelength filter 21 to advance in a direction perpendicular to the substrate surface 503 to be directed toward an optical fiber collimator 41. Also, light reflected by the optical wavelength filter 21 passes through the silicon substrate 201 to reach the high reflection coating film 31 to be reflected and advances again in the silicon substrate 201 to reach an optical wavelength filter 22 formed on the substrate surface 501 of the silicon substrate 201. Here, by adjusting the optical wavelength filter 22 in characteristics, it is possible to make light of wavelength λ2 and light of wavelength λ3, respectively, enter the optical fiber collimators 42, 43 in the same manner as the light of wavelength λ1.

Here, light outgoing toward any one of the optical fiber collimators is perpendicular to the substrate surface 503 of the silicon substrate 201 in the same manner as light of wavelength λ1. Accordingly, since any one of the optical fiber collimators can be arranged perpendicularly to the substrate surface 503 of the silicon substrate 201, the present optical multiplexer/demultiplexer can be formed to be made small.

Also, the construction of the present embodiment enables fabrication in simple wafer processes shown in FIGS. 5 and 6 and suited to mass-production in the same manner as Embodiment 1.

The present construction is of course effective in the case where an optical signal as used is of dual wavelength. FIG. 23 is a cross sectional view in case of dual wavelength. Also, it goes without saying that fabrication in wafer processes shown in FIG. 6 is possible in case of dual wavelength.

### Embodiment 8

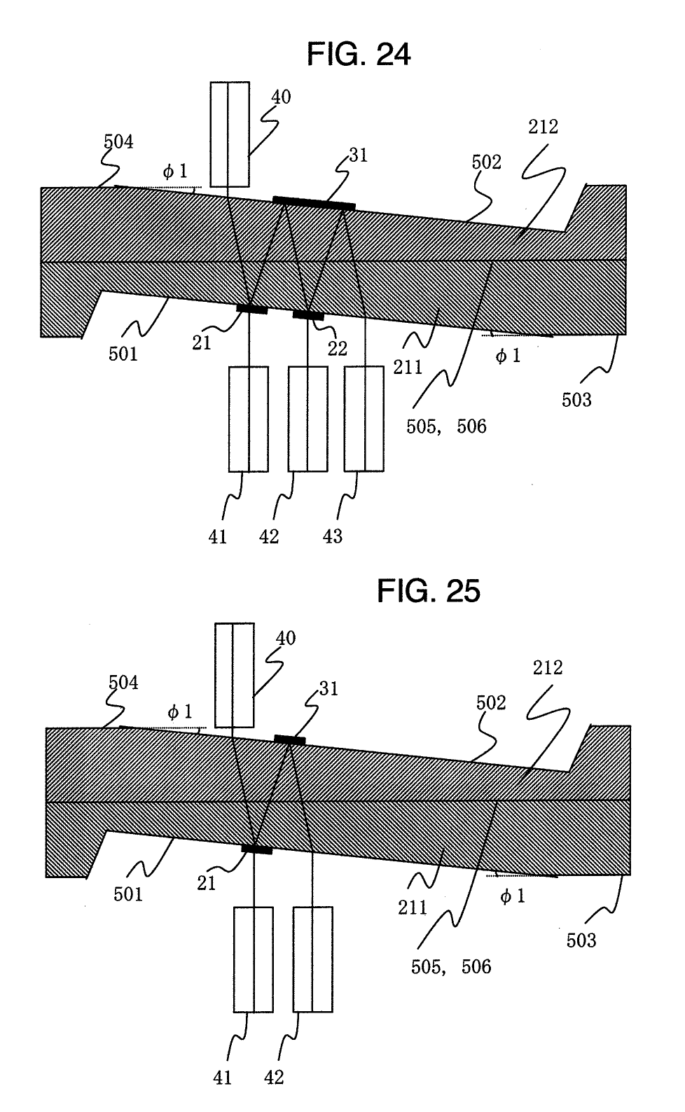

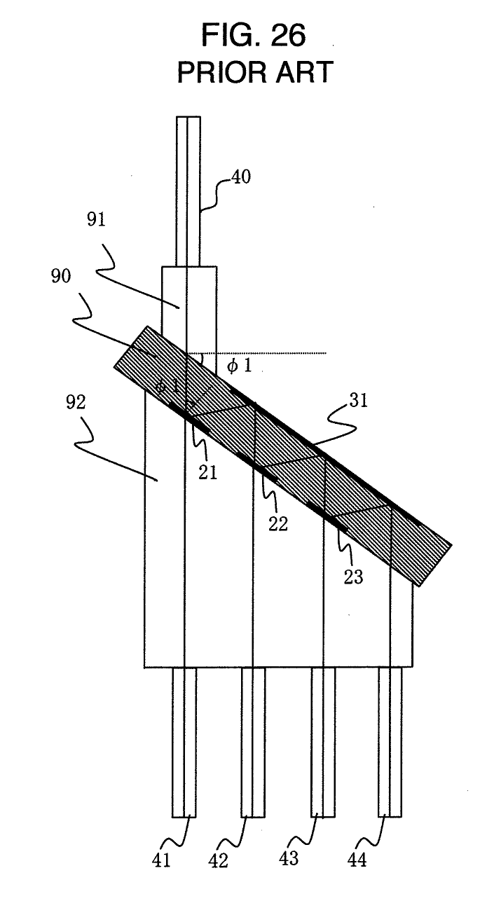

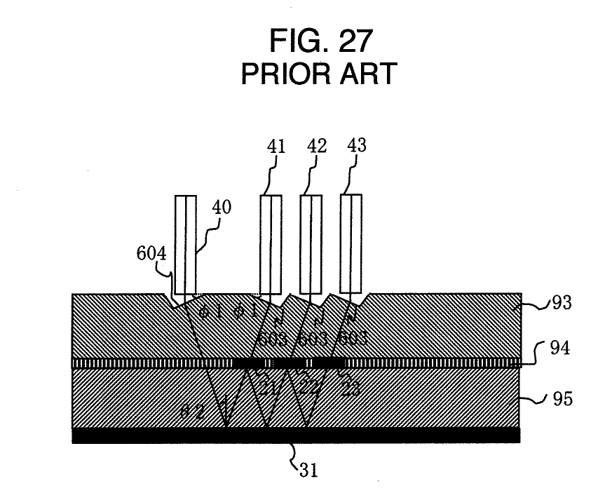

FIG. 24 is a cross sectional view showing Embodiment 8 of the invention. The present construction comprises silicon substrates 211, 212 as worked. In the construction, an inclined surface 501 having an angle φ1 of inclination is formed on one 503 of substrate surfaces of the silicon substrate 211 and an inclined surface 502 having the same angle φ1 of inclination is formed also on the other 504 of substrate surfaces of the silicon substrate 212. A substrate surface 505 of the silicon substrate 211, on which the inclined surface 501 is not formed, and a substrate surface 506 of the silicon substrate 212, on which the inclined surface 502 is not formed, are stuck together so as to make the inclined surface 501 of the silicon substrate 211 and the inclined surface 502 of the silicon substrate 212 in parallel to each other. Further, optical wavelength filters 21, 22 are formed on the inclined surface 501 and a high reflection coating film 31 is formed on the inclined surface 502. Here, in the case where the present construction is used for an optical demultiplexer, it suffices that from an optical fiber collimator 40, a signal light having different wavelengths λ1, λ2, . . . enters in a direction toward the inclined surface 502 and perpendicular to the substrate surface 504. The light is refracted by the inclined surface 502 to thereafter advance in the silicon substrates 212, 211 to reach the optical wavelength filter 21. Here, when the optical wavelength filter 21 is set in characteristics so as to transmit therethrough only light of wavelength λ1 and to reflect light of other wavelengths, the light of wavelength λ1 is refracted and transmitted through the optical wavelength filter 21 to advance in a direction perpendicular to the substrate surface 503 to be directed toward an optical fiber collimator 41. Also, light reflected by the optical wavelength filter 21 passes through the silicon substrates 211, 212 to reach the high reflection coating film 31 to be thereafter reflected and advances again in the silicon substrates 212, 211 to reach the optical wavelength filter 22 formed on the substrate surface 501 of the silicon substrate 211. Here, by adjusting the optical wavelength filter 22 in characteristics, it is possible to make light of wavelength λ2 and light of wavelength λ3, respectively, enter the optical fiber collimators 42, 43 in the same manner as the light of wavelength λ1. Here, all lights outgoing toward the optical fiber collimators are made perpendicular to the substrate surface 503 of the silicon substrate 211 in the same manner as the light of wavelength λ1. Accordingly, since any one of the optical fiber collimators can be arranged perpendicularly to the substrate surface 503 of the silicon substrate 211, the present optical multiplexer/demultiplexer can be formed to be made small. Also, the construction of the present embodiment enables fabrication in simple wafer processes shown in FIGS. 5 and 6 and suited to mass-production in the same manner as that of Embodiment 1.

The present construction is of course effective in the case where an optical signal as used is of dual wavelength. FIG. 25 is a cross sectional view in case of dual wavelength. Also, it goes without saying that fabrication in wafer processes shown in FIG. 6 is possible in case of dual wavelength.

While a material of an optical multiplexer/demultiplexer has been described taking silicon as an example, the invention is effective irrespective of a material. Also, while the function has been described mainly taking a demultiplexer as an example, it goes without saying that the optical multiplexer/demultiplexer according to the invention has a multiplexing function and a multiplexing and demultiplexing function.

It should be further understood by those skilled in the art that although the foregoing description has been made on embodiments of the invention, the invention is not limited thereto and various changes and modifications may be made without departing from the spirit of the invention and the scope of the appended claims.

1. An optical multiplexer/demultiplexer comprising
a member, of which first and second opposite planar surfaces are parallel to each other, and
wherein the member includes therein a void, of which third and fourth opposite planar surfaces are in parallel to each other,
an extension of a first line lying on the first planar surface and an extension of a third line lying on the third planar surface intersect each other in a cross section including the void of the member, a smaller one of intersection angles thereof being φ1,
an extension of a second line lying on the second planar surface and an extension of a fourth line lying on the fourth planar surface intersect each other, a smaller one of intersection angles thereof being φ1,
the third planar surface is provided on a part thereof with at least one high reflection coating film,
the fourth planar surface is provided on a part thereof with at least one optical wavelength filter,
at least parts of the high reflection coating film and the first optical wavelength filter are opposed to each other,
the first optical wavelength filter transmits therethrough light of wavelength λ1 and reflects light of wavelength λ2 (here, wavelength λ1 wavelength λ2), and
the member and an interior of the void are different in value of refractive index from each other.

2. The optical multiplexer/demultiplexer according to claim 1, wherein a second optical wavelength filter is provided on a part of the fourth planar surface,
at least parts of the high reflection coating film and the second optical wavelength filter are opposed to each other,
light entering the first optical wavelength filter has wavelengths of λ1, λ2, and λ3 (here, λ1≠λ2≠λ3)
the first optical wavelength filter transmits therethrough the light of wavelength λ1 and reflects the light of wavelength λ2 and the light of wavelength λ3, and
the second optical wavelength filter transmits therethrough the light of wavelength λ2 and reflects the light of wavelength λ3.

3. The optical multiplexer/demultiplexer according to claim 1, wherein the member comprises first and second members, or is formed from first and second members, and the first and second members are made of silicon.

4. The optical multiplexer/demultiplexer according to claim 1, wherein a wavelength division multiplexed light incident in a direction normal to the first planar surface and having components of the wavelength λ1 and the wavelength λ2 passes through the member to reach the third planar surface to be refracted at an angle θ2 to a direction normal to the third planar surface to pass through the void to enter the first optical wavelength filter at an angle θ2 to a direction normal to that plane, in which the optical wavelength filter on the fourth planar surface is present,
the wavelength division multiplexed light incident upon the first optical wavelength filter has a light component of the wavelength λ1 transmitted to reach the second planar surface to pass therethrough,
the wavelength division multiplexed light, from which the wavelength λ1 is removed and which has the wavelength λ2, is reflected by the first optical wavelength filter and the high reflection coating film to pass through the void and the member to reach the second planar surface to outgo outside thereof, and
the φ1 and θ2 meet n1×sin φ1=n2×sin θ2 (Snell's law) where n1 indicates a refractive index value of the member and n2 indicates a refractive index value of the void in a reduced-pressure atmosphere, or a refractive index value of gases, an air, or a filler in the void.

5. The optical multiplexer/demultiplexer according to claim 4, wherein the wavelength division multiplexed light having the wavelength λ1 and the wavelength λ2 enters the first planar surface through a first optical fiber or a first optical fiber collimator,
the light component of the wavelength λ1 outgoes outside the second planar surface through a second optical fiber or a second optical fiber collimator, and
the light component of the wavelength λ2 outgoes outside the second planar surface through a third optical fiber or a third optical fiber collimator.

6. The optical multiplexer/demultiplexer according to claim 1, wherein an interior of the void is in a reduced-pressure atmosphere, or has an air or gases made present therein, or is filled with a substance, through which a wavelength division multiplexed light having the wavelength λ1 and the wavelength λ2 can pass.

7. The optical multiplexer/demultiplexer according to claim 3, wherein the first planar surface of the first member comprises a first substrate surface, the third planar surface of the first member comprising a planar surface on the back side of the first planar surface, the planar surface being one of crystal planes, and
the second planar surface of the second member comprises a second substrate surface, the fourth planar surface of the second member comprising a planar surface on the back side of the second planar surface, the planar surface being one of crystal planes.

8. An optical multiplexer/demultiplexer comprising
a member, of which first and second opposite planar surfaces are in parallel to each other, and
wherein the member includes therein a void, of which third and fourth opposite planar surfaces are in parallel to each other,
the first planar surface and the third planar surface are in parallel to each other,
the first planar surface is partially removed to provide a fifth planar surface, a normal direction of the first planar surface and a normal direction of the fifth planar surface intersecting each other at an angle φ1,
a high reflection coating film is provided on a part of the first planar surface, at least one optical wavelength filter being provided on a part of the third or fourth planar surface,
at least parts of the high reflection coating film and the first optical wavelength filter are opposed to each other with a part of the member therebetween,
the second planar surface is partially removed to provide sixth and seventh planar surfaces separately from each other, a normal direction of the second planar surface and a normal direction of the sixth and seventh planar surfaces intersecting each other at an angle φ1, the fifth planar surface, the sixth planar surface, and the seventh planar surface being in parallel to one another, and
the first optical wavelength filter transmits therethrough light of wavelength λ1 and reflects light of wavelength λ2.

9. The optical multiplexer/demultiplexer according to claim 8, wherein a second optical wavelength filter is provided on a part of the third or fourth planar surface,
at least parts of the high reflection coating film and the second optical wavelength filter are opposed to each other,
light incident upon the first optical wavelength filter has wavelengths of λ1, λ2, and λ3 (here, λ1≠λ2≠λ3),
the first optical wavelength filter transmits therethrough light of wavelength λ1 and reflects light of wavelength λ2 and light of wavelength λ3, and
the second optical wavelength filter transmits therethrough the light of wavelength λ2 and reflects the light of wavelength λ3.

10. The optical multiplexer/demultiplexer according to claim 8, wherein the member comprises first and second members, the first, third, and fifth planar surfaces lie on the first member, the second, fourth, sixth, and seventh planar surfaces lie on the second member.

11. The optical multiplexer/demultiplexer according to claim 8, wherein a spacer is provided between the first and second members.

12. The optical multiplexer/demultiplexer according to claim 8, wherein a wavelength division multiplexed light incident on the fifth planar surface in a direction normal to the first planar surface and having components of the wavelength λ1 and the wavelength λ2 passes through the member to enter the first optical wavelength filter on the third planar surface,
the wavelength division multiplexed light incident upon the first optical wavelength filter has a light component of the wavelength λ1 transmitted, light having the transmitted light component of the wavelength λ1 is refracted according to Snell's law to thereafter pass through the void to pass through the member to pass through the sixth planar surface to reach an outside of the member,
the wavelength division multiplexed light, from which the wavelength λ1 is removed and which has the wavelength λ2, is reflected by the third optical wavelength filter to pass through the member to be reflected by the high reflection coating film to be refracted by the third planar surface according to Snell's law to pass through the void to pass through the member to reach the seventh planar surface to reach an outside of the member.

13. The optical multiplexer/demultiplexer according to claim 12, wherein a wavelength division multiplexed light having light components of the wavelength λ1 and the wavelength λ2 enters the first planar surface through a first optical fiber or a first optical fiber collimator,
the light component of the wavelength λ1 outgoes outside the sixth planar surface through a second optical fiber or a second optical fiber collimator, and
the light component of the wavelength λ2 outgoes outside the seventh planar surface through a third optical fiber or a third optical fiber collimator.

14. The optical multiplexer/demultiplexer according to claim 8, wherein an interior of the void is in a reduced-pressure atmosphere, or has an air or gases made present therein, or is filled with a substance, through which a wavelength division multiplexed light having the wavelength λ1 and the wavelength λ2 can pass.

15. The optical multiplexer/demultiplexer according to claim 10, wherein the fifth planar surface is one of crystal orientation planes of the first member and the sixth and seventh planar surfaces are one of crystal orientation planes of the second member.

16. An optical multiplexer/demultiplexer comprising
a member having first and second planar surfaces, which are in parallel to each other, and
wherein at least one high reflection coating film is provided on the first planar surface, at least one optical wavelength filter is provided on the second planar surface,
at least parts of the high reflection coating film and the first optical wavelength filter are opposed to each other, and
the first optical wavelength filter transmits therethrough light of wavelength λ1 and reflects light of wavelength λ2, which is different from the wavelength λ1.

17. The optical multiplexer/demultiplexer according to claim 16, wherein the member comprises first and second members, or is formed from first and second members, and the first and second members are made of silicon.

18. The optical multiplexer/demultiplexer according to claim 16, wherein the member is inclined at an angle φ1 to a reference planar surface in a cross section of the member,
a wavelength division multiplexed light incident upon the first planar surface in a direction normal to the reference planar surface on the first planar surface and having components of the wavelength λ1 and the wavelength λ2 passes through the member to reach the second planar surface,
light having a light component of the wavelength λ1 and transmitted through the first optical wavelength filter outgoes outside the member, and light, from which the wavelength λ1 is removed by the first optical wavelength filter and which has the wavelength λ2, is reflected by the high reflection coating film to pass through the member to outgo outside the member.

19. The optical multiplexer/demultiplexer according to claim 16, wherein the first member includes third and fourth planar surfaces, which are in parallel to each other, the first planar surface being provided by partially removing the third planar surface,
a direction, in which the first planar surface extends, and a direction, in which the third planar surface, intersect each other at an angle φ1,
the second member includes fifth and sixth planar surfaces, which are in parallel to each other, the second planar surface being provided by partially removing the sixth planar surface,
a direction, in which the second planar surface extends, and a direction, in which the sixth planar surface extends, intersect each other at an angle φ1, and
the fourth planar surface and the fifth planar surface are in contact with each other.

20. The optical multiplexer/demultiplexer according to claim 18, wherein the wavelength division multiplexed light enters the first planar surface through a first optical fiber or a first optical fiber collimator,
the light component of the wavelength λ1 outgoes outside the second planar surface through a second optical fiber or a second optical fiber collimator, and
the light component of the wavelength λ2 outgoes outside the second planar surface through a third optical fiber or a third optical fiber collimator.
